(19) United States
(12) Patent Application Publication
(10) Pub. No.: US 2005/0097980 A1
(43) Pub. Date: May 12, 2005

(54) Kickdown mechanism

(76) Inventor: Brad Menzies, Holly, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/761,638

(22) Filed: Jan. 21, 2004

Related U.S. Application Data
(60) Provisional application No. 60/518,207, filed on Nov. 7, 2003.

(51) Int. Cl. G05G 1/14

(52) U.S. Cl. 74/512

(57) ABSTRACT

A kickdown mechanism (12) to provide a kickdown feel to an operator of a pedal assembly (10) is provided. The kickdown mechanism (12) includes a housing (24) that defines a chamber. A plunger (38) is slidable within the chamber (30) along an operational axis (A) while being biased by a spring (44). Detent members (54, 56) contact bearing surfaces (40, 42) of the plunger (38). The detent members (54, 56) are movable between an initial position and a plurality of active positions against the bias of the spring (44) while maintaining contact with the bearing surfaces (40, 42). An actuator (66) engages the detent members (54, 56) and moves the detent members (54, 56) from the initial position to the plurality of active positions when engaged by the pedal arm (16). The bearing surfaces (40, 42) act as a wedge to urge the detent members (54, 56) back to the initial position when the pedal arm (16) is disengaged from the actuator (66).

### RELATED APPLICATIONS

This application claims the benefit of U.S. Provisional Patent Application Ser. No. 60/518,207, filed Nov. 7, 2003.

### FIELD OF THE INVENTION

The present invention relates generally to a kickdown mechanism for use in a pedal assembly to provide a kickdown feel to an operator of the pedal assembly. More specifically, the present invention relates to the kickdown mechanism having detent members for providing the kickdown feel to the operator of the pedal assembly.

### BACKGROUND OF THE INVENTION

Prior art pedal assemblies generally comprise a pedal housing attached to a vehicle body and a pedal arm pivotally supported by the pedal housing. A series of links and levers, or cables, mechanically connect the pedal assembly to a kickdown device. The kickdown device is used to initiate a kickdown, i.e., a downshift to a next lower gear in an automatic transmission. Typically, such downshifts occur when an operator desires fast acceleration. When the pedal arm is pivoted from an idle position to a predetermined operable position, the kickdown device is mechanically engaged to downshift the automatic transmission. An added force is required to further pivot the pedal arm when the kickdown device is mechanically engaged. This added force provides a sensation to the operator that is commonly referred to as a kickdown feel, i.e., the operator can “feel” when the kickdown device is engaged, and hence, when the automatic transmission downshifts to the next lower gear.

Consequently, a large amount of packaging space must be provided within the vehicle to accommodate the mechanical connections to the kickdown device. However, the space available for the mechanical connections is limited. Hence, recent improvements in the prior art use electrical connections in place of the mechanical connections. Instead of using the mechanical connections to mechanically transmit a position of the pedal arm to the kickdown device, an electrical generator is used to electrically transmit the position of the pedal arm to control the kickdown device. Replacing the mechanical connections with electrical connections reduces the necessary packaging space for the pedal assembly.

Unfortunately, without the mechanical connections, electronic pedal assemblies do not provide the customary feel and performance of a mechanically connected pedal assembly. In other words, the pedal assembly does not provide the kickdown feel to the operator when the downshift occurs, i.e., the user cannot “feel” when the downshift occurs. To solve this problem, manufacturers incorporate a kickdown mechanism in the electronic pedal assembly to provide the kickdown feel to the operator. The kickdown mechanism is markedly different than the kickdown device described above. The kickdown device is mechanically connected to the pedal assembly via a link or cable and mechanically initiates the downshift in the automatic transmission. Conversely, the kickdown mechanism in an electronic pedal assembly does not initiate the downshift. In this instance, the kickdown mechanism is a stand-alone mechanism simply used to simulate the kickdown feel for the operator.

An example of a kickdown mechanism used in an electronic pedal assembly to simulate a kickdown feel is shown in U.S. Pat. No. 6,418,813 to Lewis. The pedal assembly of Lewis comprises a pedal housing and a pedal arm pivotally engaging the pedal housing. The kickdown mechanism is mounted to the pedal housing. The kickdown mechanism comprises a housing that defines a chamber for receiving a plunger. The plunger defines a detent pocket and is slidable within the chamber when engaged by the pedal arm. A first spring biases the plunger toward the pedal arm. A detent member is movable between an initial position in the detent pocket and a plurality of active positions out from the detent pocket. The detent member moves out from the detent pocket when the plunger is engaged by the pedal arm to provide the kickdown feel. A second spring biases the detent member back to the initial position after the pedal arm is disengaged from the plunger.

### BRIEF SUMMARY OF THE INVENTION

The present invention provides a kickdown mechanism for use with a pedal arm to provide a kickdown feel to an operator of the pedal arm. The kickdown mechanism includes a housing defining a chamber. An operational axis is defined through the chamber. A resilient member is movable within the chamber along the operational axis. The resilient member presents a bearing surface. A detent member is in contact with the bearing surface and is moveable between an initial position and a plurality of active positions against the bias of the resilient member while maintaining contact with the bearing surface. A force required to move the detent member from the initial position to the plurality of active positions provides the kickdown feel to the operator. An actuator is spaced from the resilient member and engages the detent member to move the detent member from the initial position to the plurality of active positions when engaged by the pedal arm. The kickdown mechanism is characterized by the bearing surface being disposed at an acute angle to the operational axis to urge the detent member back to the initial position under the bias of the resilient member.

The present invention provides several advantages over the prior art. Notably, the combination of the angled bearing surface and the bias of the resilient member provides a robust kickdown mechanism having a simple configuration. More specifically, by using this combination, a separate spring, such as the second spring of the '813 patent, is not needed to urge the detent member back to the initial position. Instead, the angled bearing surface transfers the bias of the resilient member both axially and radially to the detent member to move the detent member back to the initial position when the pedal arm is disengaged from the actuator.

### BRIEF DESCRIPTION OF THE SEVERAL VIEWS OF THE DRAWINGS

Advantages of the present invention will be readily appreciated as the same becomes better understood by reference to the following detailed description when considered in connection with the accompanying drawings wherein:

FIG. 1 is a perspective view of a kickdown mechanism of the present invention in a pedal assembly;

FIG. 2 is an exploded view of the kickdown mechanism taken from a left perspective;

FIG. 3 is an exploded view of the kickdown mechanism taken from a right perspective;

FIG. 4A is a cross-sectional view of the kickdown mechanism illustrating detent members in an initial position;

FIG. 4B is a cross-sectional view of the kickdown mechanism illustrating the detent members in an active position;

FIG. 5A is an illustrative view of the kickdown mechanism taken generally along the line 4A-4A to illustrate the detent members in the initial position; and

FIG. 5B is an illustrative view of the kickdown mechanism taken generally along the line 4B-4B to illustrate the detent members in the active position.

### DETAILED DESCRIPTION OF THE INVENTION

Referring to the Figures, wherein like numerals indicate like or corresponding parts throughout the several views, a kickdown mechanism for use with a pedal assembly 10 to provide a kickdown feel to an operator of the pedal assembly 10 is generally shown at 12.

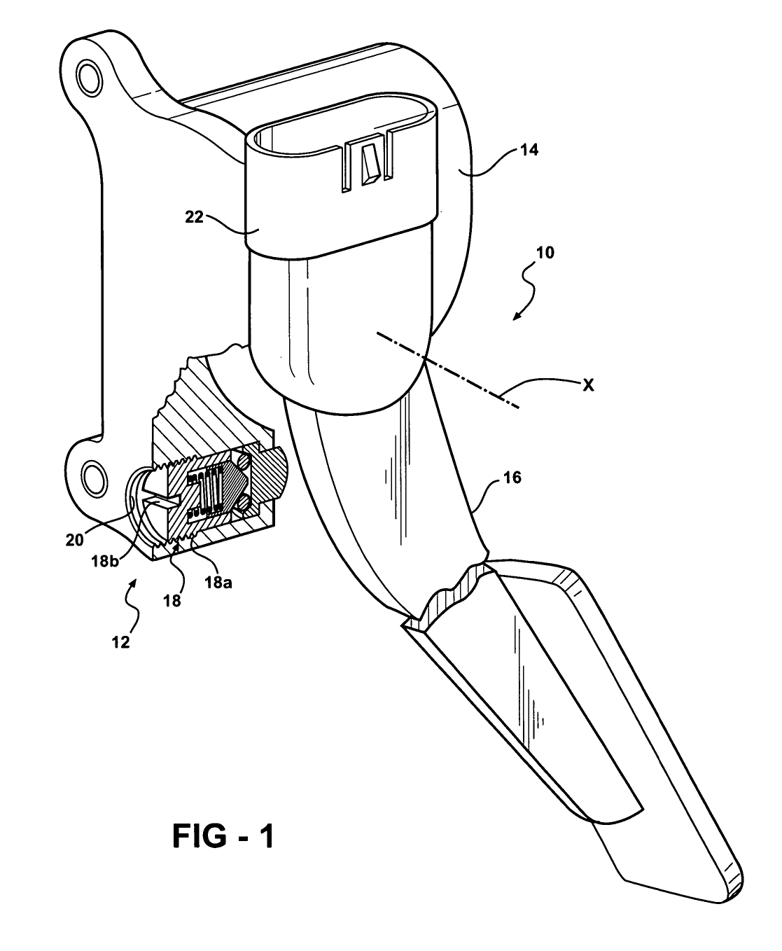

Referring to FIG. 1, the kickdown mechanism 12 is mounted to the pedal assembly 10. The pedal assembly 10 comprises a pedal housing 14 and a pedal arm 16 pivotally supported by the pedal housing 14 for moving between an idle position and a plurality of operable positions about an axis X. The pedal arm 16 is preferably formed from steel or polymeric material and the pedal housing 14 is preferably made from a polymeric material such as nylon. The kickdown mechanism 12 includes an adjustment device 18, e.g., threads 18a and slot 18b, for adjustably mating with a threaded bore 20 of the pedal housing 14. The kickdown mechanism 12 is positioned within the threaded bore 20 for actuation by the pedal arm 16.

An electrical generator 22 is supported by the pedal housing 14. The electrical generator 22 generates a control signal that varies in magnitude in proportion to the extent of movement of the pedal arm 16 relative to the pedal housing 14. The electrical generator 22 is typically a potentiometer. However, other generators or sensors known in the art can be used such as non-contact Hall effect sensors, and the like. When the control signal reaches a predetermined magnitude, a controller (not shown) initiates a kickdown, i.e., downshift of an automatic transmission (not shown) to a next lower gear, as is well known to those skilled in the art. The adjustment device 18 of the kickdown mechanism 12 adjusts a position of the kickdown mechanism 12 relative to the pedal arm 16 to synchronize the kickdown feel with generation of the control signal at the predetermined magnitude. This synchronizes the kickdown feel with the downshift of the automatic transmission to closely replicate mechanical kickdown devices.

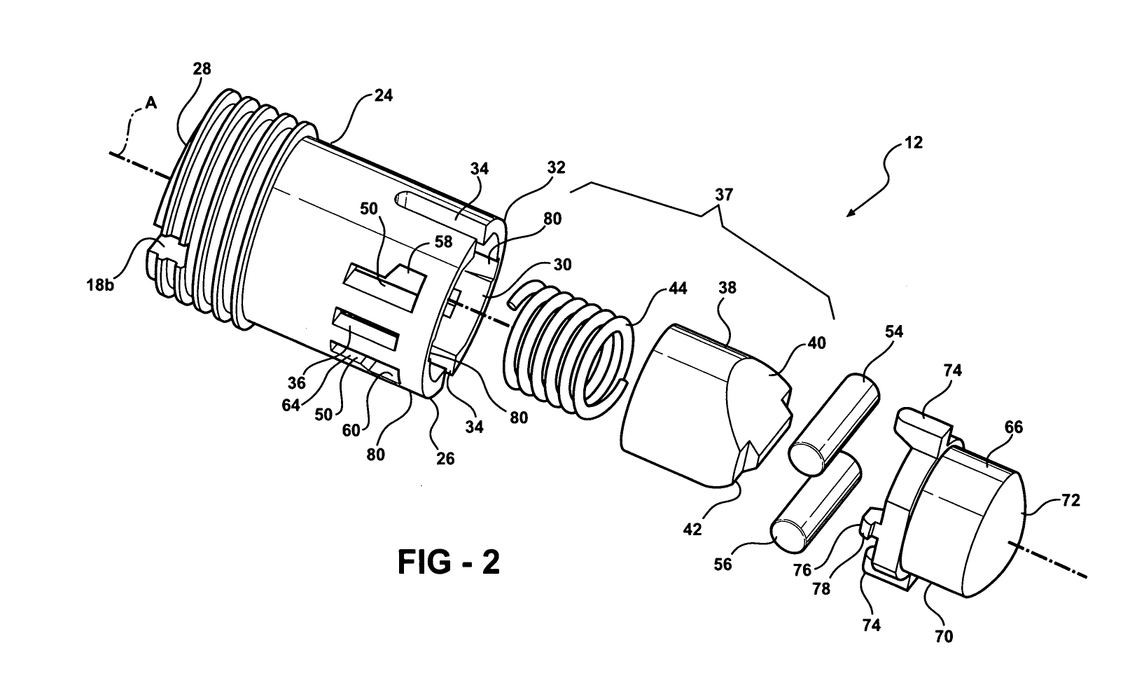

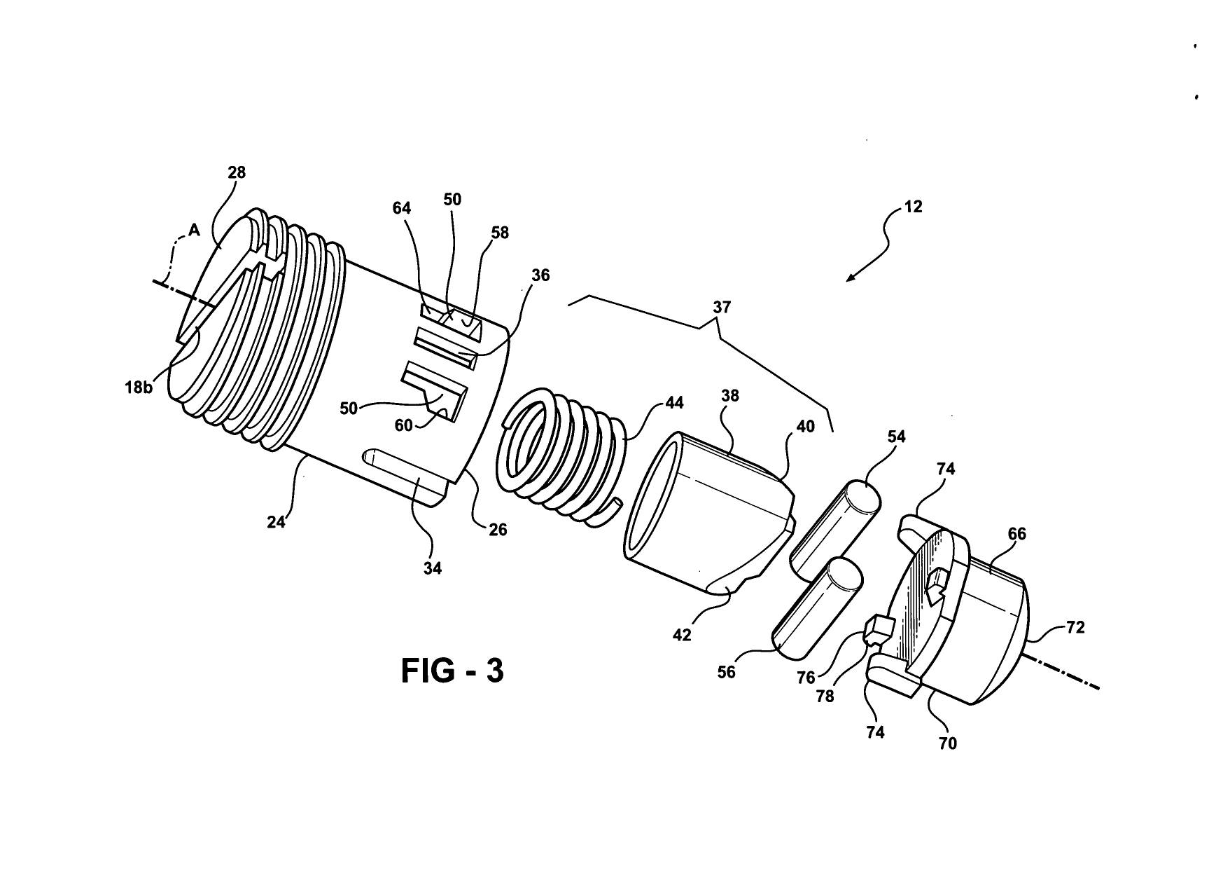

Referring to FIGS. 2 and 3, the kickdown mechanism 12 includes a housing 24 having an open end 26 and a closed end 28 spaced therefrom. The housing 24 defines a chamber 30 between the ends 26, 28 and an operational axis A through the chamber 30. The housing 24 and chamber 30 are generally cylindrical in shape. The housing 24 includes a sidewall 32 defining a first 34 and second 36 pair of elongated slots therein. Each of the first pair of elongated slots 34 opens into the open end 26 of the housing 24 and terminates along the sidewall 32 between the ends 26, 28. Each of the second pair of elongated slots 36 is fully enclosed by the sidewall 32. Both pairs of elongated slots 34, 36 are parallel to the operational axis A. The housing 24 is preferably formed from plastic.

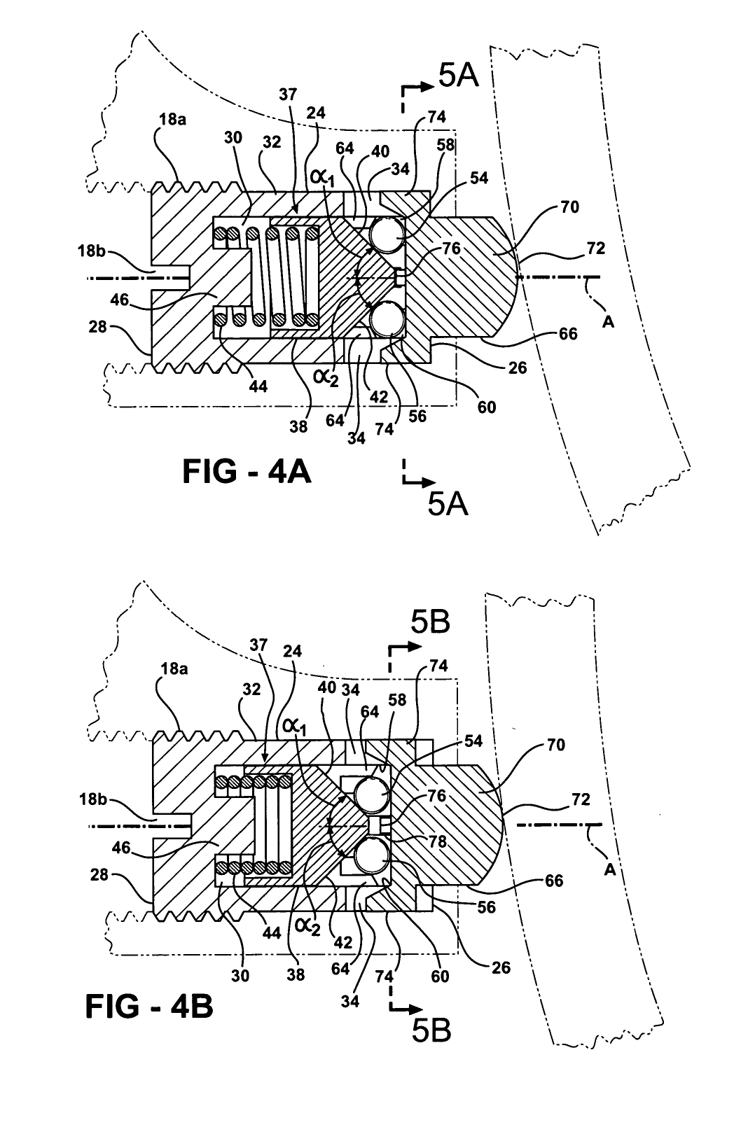

Referring to FIGS. 4A and 4B, a resilient member 37 moves within the chamber 30 along the operational axis A. The resilient member 37 comprises a plunger 38 that slides within the chamber 30 along the operational axis A. The plunger 38 is generally cylindrical in shape to mate with the generally cylindrical shape of the chamber 30. The plunger 38 presents first 40 and second 42 bearing surfaces disposed at first α₁ and second α₂ acute angles relative to the operational axis A. Preferably, the acute angles α₁, α₂ are between thirty and sixty degrees. More preferably, the acute angles α₁, α₂ are forty-five degrees. The plunger 38 is preferably formed from plastic. The resilient member 37 further comprises a spring 44 disposed within the chamber 30 between the closed end 28 of the housing 24 and the plunger 38 to bias the plunger 38, i.e., to provide a biasing force of the resilient member 37. The closed end 28 of the housing 24 includes an embossed portion 46 axially protruding into the chamber 30 along the operational axis A and the plunger 38 defines a bore coaxial with the embossed portion 46. The spring 44 includes a first end seated over the embossed portion 46 and a second end seated with the bore. Thus, the spring 44 biases the plunger 38 axially away from the closed end 28 of the housing 24 and toward the open end 26 along the operational axis A. The spring 44 is preferably made from metal such as steel.

First 54 and second 56 detent members are in contact with the bearing surfaces 40, 42 of the plunger 38 in the housing 24. The detent members 54, 56 are movable between an initial position and a plurality of active positions against the biasing force of the resilient member 37 while maintaining contact with the bearing surfaces 40, 42. The detent members 54, 56 are further defined as rollers 54, 56. The rollers 54, 56 are preferably formed from metal such as steel.

In the initial position, shown in FIG. 4A, the detent members 54, 56 are positioned against the bearing surfaces 40, 42 and within first 58 and second 60 pairs of detent pockets defined in the sidewall 32 of the housing 24. The bearing surfaces 40, 42 define a wedge between the detent members 54, 56. The wedge urges the detent members 54, 56 into the initial position, i.e., into the detent pockets 58, 60, under the biasing force of the resilient member 37.

In the plurality of active positions, one of which is shown in FIG. 4B, the detent members 54, 56 move out from the detent pockets 58, 60 against the bias of the plunger 38. When this occurs, the detent members 54, 56 move axially and radially along the bearing surfaces 40, 42 relative to the operational axis A. A force is required to move the detent members 54, 56 out from the detent pockets 58, 60 and against the biasing force of the resilient member 37, i.e., from the initial position to the plurality of active positions. This force provides the kickdown feel to the operator.

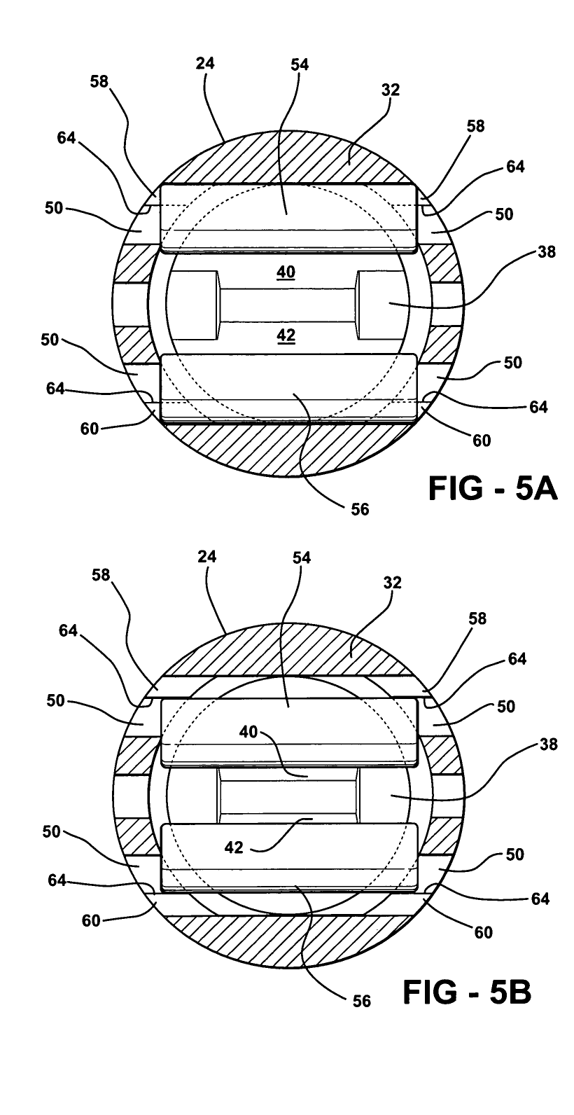

Referring to FIGS. 2, 3, 5A, and 5B, each of the detent pockets 58, 60 are defined by windows 50 formed in the sidewall 32 of the housing 24. Each of the windows 50 assumes an L-shape or backward L-shape. By cutting such a shape into the sidewall 32 of the housing 24, as shown in FIGS. 2 and 3, the detent pockets 58, 60 are formed. Likewise, when these shapes are cut into the sidewall 32, each of the windows 50 forms a shoulder 64 in the chamber 30. The shoulders 64 urge the detent members 54, 56 out from the detent pockets 58, 60 as the detent members 54, 56 move from the initial position to the plurality of active positions. In other words, the detent members 54, 56 must climb the shoulders 64 to move out from the detent pockets 58, 60.

An actuator 66 is disposed within the open end 26 of the housing 24. The actuator 66 is spaced from the plunger 38 and engages the detent members 54, 56 to move the detent members 54, 56 from the initial position to the plurality of active positions, i.e., out from the detent pockets 58, 60, when engaged by the pedal arm 16. The actuator 66 is slidable within the chamber 30 along the operational axis A to move the detent members 54, 56. A distance between the actuator 66 and the plunger 38 increases as the detent members 54, 56 move from the initial positions to the active positions. The actuator 66 includes a front end and a projection 70 disposed thereon for engaging the pedal arm 16. The projection 70 protrudes from the open end 26 of the housing 24. The projection 70 is preferably cylindrical in shape with a rounded end 72 that contacts the pedal arm 16.

The actuator 66 includes a first pair of guide members 74 for reciprocating within the first pair of elongated slots 34 during operation of the kickdown mechanism 12. The actuator 66 also includes a second pair of guide members 76 for reciprocating within the second pair of elongated slots 36 during operation of the kickdown mechanism 12. Each of the second pair of guide members 76 includes a detent tab 78 for springably engaging one of the second pair of elongated slots 36 to retain the actuator 66 within the chamber 30. The sidewall 32 includes a pair of ramps 80 for guiding the detent tabs 78 into the second pair of elongated slots 36 during assembly. The actuator 66 is preferably formed from plastic.

The first detent member 54, the first bearing surface 40, and the first pair of detent pockets 58 mirror the second detent member 56, the second bearing surface 42, and the second pair of detent pockets 60 relative to the operational axis A. In other words, the first detent member 54, the first bearing surface 40, and the first pair of detent pockets 58 are disposed in an upper portion of the chamber 30 while the second detent member 56, the second bearing surface 42, and the second pair of detent pockets 60 are disposed in a lower portion of the chamber 30 equidistant from the upper portion relative to the operational axis A. This arrangement balances forces acting within the kickdown mechanism 12 relative to the operational axis A to reduce wear and increase the longevity of the kickdown mechanism 12.

In operation, the pedal arm 16 engages the actuator 66 when the pedal arm 16 is pivoted to a predetermined operable position from the idle position. More specifically, the pedal arm 16 engages the rounded end 72 of the projection 70 when the pedal arm 16 is pivoted to the predetermined operable position. The force required to press the actuator 66 once engaged by the pedal arm 16 provides the kickdown feel. Preferably, the kickdown feel occurs when the pedal arm 16 achieves nearly full travel, i.e., close to a maximum travel position. However, other activation points can be utilized.

FIG. 4A shows the detent members 54, 56 in the initial position with the pedal arm 16 at the predetermined operable position. In this position, the pedal arm 16 has just engaged the projection 70, thus initiating the kickdown feel. FIG. 4B shows the pedal arm 16 in the maximum travel position. Here, the downshift has already occurred and the operator has already experienced the kickdown feel via movement of the detent members 54, 56 from the initial position to the plurality of active positions, i.e., out from the detent pockets 58, 60.

The operator must apply enough force to not only urge the detent members 54, 56 from the detent pockets 58, 60, but to also overcome the biasing effect of the spring 44 on the plunger 38 when moving the pedal arm 16 from the predetermined operable position toward the maximum travel position. When the detent members 54, 56 are in one of the plurality of active positions and the user releases the pedal arm 16, e.g., to decelerate, the spring 44 biases the plunger 38, detent members 54, 56, and actuator 66 back toward the pedal arm 16 thereby wedging the detent members 54, 56 back into the detent pockets 58, 60.

Obviously, many modifications and variations of the present invention are possible in light of the above teachings. The invention may be practiced otherwise than as specifically described within the scope of the appended claims, wherein that which is prior art is antecedent to the novelty set forth in the “characterized by” clause. The novelty is meant to be particularly and distinctly recited in the “characterized by” clause whereas the antecedent recitations merely set forth the old and well-known combination in which the invention resides. These antecedent recitations should be interpreted to cover any combination in which the incentive novelty exercises its utility. In addition, the reference numerals in the claims are merely for convenience and are not to be read in any way as limiting.

1. A kickdown mechanism (12) for use with a pedal arm (16) to provide a kickdown feel to an operator of the pedal arm (16), said mechanism comprising;
a housing (24) defining a chamber (30),
a resilient member (37) presenting a bearing surface (40) movable within said chamber (30) along an operational axis (A),
a detent member (54) in contact with said bearing surface (40) and movable between an initial position and a plurality of active positions against a biasing force of 1o said resilient member (37) while maintaining contact with said bearing surface (40) whereby a force required to move said detent member (54) from said initial position to said plurality of active positions provides the kickdown feel to the operator, and
an actuator (66) engaging said detent member (54) for moving said detent member (54) from said initial position to said plurality of active positions when engaged by the pedal arm (16),
said assembly characterized by said bearing surface (40) being disposed at an acute angle (α₁) to said operational axis (A) to urge said detent member (54) back to said initial position under the bias of said resilient member (37) when the pedal arm (16) is disengaged from said actuator (66).

2. A mechanism as set forth in claim 1 wherein said acute angle (α₁) is between thirty and sixty degrees.

3. A mechanism as set forth in claim 2 wherein said acute angle (α₁) is forty-five degrees.

4. A mechanism as set forth in claim 1 wherein said resilient member (37) presents a second bearing surface (42) positioned at a second acute angle (α₂) to said operational axis (A).

5. A mechanism as set forth in claim 4 including a second detent member (56) in contact with said second bearing surface (42) and movable between an initial position and a plurality of active positions against the bias of said resilient member (37) while maintaining contact with said second bearing surface (42).

6. A mechanism as set forth in claim 5 wherein said detent members (54, 56) and said bearing surfaces (40, 42) mirror one another relative to said operational axis (A).

7. A mechanism as set forth in claim 6 wherein said housing (24) includes a sidewall (32) and said sidewall (32) defines first (58) and second (60) pairs of detent pockets for receiving said detent members (54, 56).

8. A mechanism as set forth in claim 7 wherein said first (40) and second (42) bearing surfaces define a wedge between said detent members (54, 56) for urging said detent members (54, 56) into said detent pockets (58, 60) under the bias of said resilient member (37).

9. A mechanism as set forth in claim 8 further including a plurality of shoulders (64) formed in said chamber (30) to further define said detent pockets (58, 60) and urge said detent members (54, 56) out from said detent pockets (58, 60) when said detent members (54, 56) are moved by said actuator (66) wherein each of said detent members (54, 56) move radially and axially along said bearing surfaces (40, 42) toward said operational axis (A) as said detent members (54, 56) move out from said detent pockets (58, 60).

10. A mechanism as set forth in claim 9 wherein said detent pockets (58, 60) and said shoulders (64) are disposed in upper and lower portions of said chamber (30) to provide a balance of forces acting upon said kickdown mechanism (12) relative to said operational axis (A).

11. A mechanism as set forth in claim 10 wherein said resilient member (37) is further defined as a plunger (38) biased by a spring (44) between said housing (24) and said plunger (38).

12. A mechanism as set forth in claim 11 wherein said actuator (66) includes a front end and a projection (70) protruding from said front end for engaging the pedal arm (16).

13. A mechanism as set forth in claim 12 wherein said housing (24) includes a sidewall (32) and a first pair of elongated slots (34) defined therein and said actuator (66) includes a first pair of guide members (74) for reciprocating within said first pair of slots (34).

14. A mechanism as set forth in claim 13 wherein said sidewall (32) defines a second pair of elongated slots (36) and said actuator (66) includes a second pair of guide members (76) for reciprocating within said second pair of elongated slots (36) wherein said second pair of elongated slots (36) are enclosed by said sidewall (32) and said second pair of guide members (76) include detent tabs (78) for engaging said second pair of elongated slots (76) to retain said actuator (66) in said housing (24).

15. A mechanism as set forth in claim 14 wherein said detent members (54, 56) are further defined as rollers (54, 56).

16. A mechanism as set forth in claim 15 wherein said rollers (54, 56) are formed from metal and said housing (24), plunger (38), and actuator (66) are formed from plastic.

17. A pedal assembly (10), comprising;
a pedal housing (14),
a pedal arm (16) pivotally supported by said pedal housing (14),
a kickdown housing (24) defining a chamber (30) near said pedal arm (16), a plurality of detent pockets (60, 62) in said chamber (30), and an operational axis (A) through said chamber (30),
a plunger (38) slidable within said chamber (30) along said operational axis (A),
a spring (44) disposed between said kickdown housing (24) and said plunger (38) for biasing said plunger (38) axially along said operational axis (A),
a pair of detent members (54, 56) seated within said detent pockets (58, 60) and moveable out from said detent pockets (58, 60) against the bias of said plunger (38) whereby a force required to move said detent members (54, 56) out from said detent pockets (58, 60) provides a kickdown feel to an operator, and
an actuator (66) for moving said detent members (54, 56) out from said detent pockets (58, 60) when engaged by said pedal arm (16),
said assembly characterized by said plunger (38) defining a wedge between said detent members (54, 56) for urging said detent members (54, 56) back into said detent pockets (58, 60) under the bias of said plunger (38) when said pedal arm (16) is disengaged from said actuator (66).

18. A mechanism as set forth in claim 17 further including an electrical generator (22) supported by said pedal housing (14) for generating a control signal that varies in magnitude in proportion to the extent of movement of said pedal arm (16) relative to said pedal housing (14).

19. A mechanism as set forth in claim 18 further including an adjustment device (18) for adjusting a position of said kickdown mechanism (12) relative to said pedal arm (16) to synchronize movement of said detent members (54, 56) out from said detent pockets (58, 60) with generation of the control signal at a predetermined magnitude.
